(19) United States
(12) Patent Application Publication
(10) Pub. No.: US 2026/0124641 A1
(43) Pub. Date: May 7, 2026

(54) METHODS FOR FORMING MATTE COATINGS

(71) Applicant: ARKEMA FRANCE, Puteaux (FR)

(72) Inventors: Jean-Yves LOZE, Serquigny (FR); Xavier DRUJON, Verneuil-en-Halatte (FR); Stefanie LAPORTE, Serquigny (FR); Maud BASSET, Verneuil-en-Halatte (FR)

(73) Assignee: ARKEMA FRANCE, Puteaux (FR)

(21) Appl. No.: 19/119,933

(22) PCT Filed: Oct. 12, 2023
(86) PCT No.: PCT/FR2023/051590

§ 371 Date: Apr. 10, 2025

(30) Foreign Application Priority Data
Oct. 12, 2022 (FR) FR2210460

(51) Int. Cl. B05D 3/06; B05D 5/02; C09D 7/42; C09D 7/63

(52) U.S. Cl. CPC B05D 3/067; B05D 5/02; C09D 7/63; B05D 2602/00; C09D 7/42

(57) ABSTRACT

A method for coating a surface, including the following steps: applying a layer of a curable composition to the surface; irradiating the curable composition with a first radiation having a wavelength of 100 to 280 nm, so as to give a partially cured composition; and irradiating the partially cured composition with a second radiation including at least one wavelength higher than the wavelength of the first radiation, and/or an electron beam, so as to give a cured composition, the curable composition including at least one compound curable by actinic radiation, and particles of at least one polyamide. Also, a coating layer obtained by such a method and to an object comprising a surface covered with such a coating layer.

### FIELD OF THE INVENTION

The present invention relates to methods for coating a surface on the basis of curable compositions which leads to a matte appearance, and to the coatings obtained by such methods.

### TECHNICAL BACKGROUND

Compositions curable or crosslinkable by actinic radiation are commonly used for forming coatings on a surface. They obviate the use of solvents, in particular, and enable rapid crosslinking.

For certain applications, a matte coating is desirable. A “matte coating” refers to a coating having a specular gloss at 85° of less than 15 GU.

One known option for obtaining such matte coatings is to add a matting agent to the curable composition in an amount sufficient for some of the agent to appear at the surface of the coating, thereby creating roughnesses on said surface. Alternatively, matting may be obtained without employing matting agents, by irradiating the coating composition with successive radiations at different wavelengths, so as initially to crosslink only a very low thickness of the coating layer, at its surface, to create folds, and then to crosslink the rest of the layer in a second phase.

However, this latter technique leads generally to a nonuniform surface roughness, owing to the alternation of highly folded zones with zones with little folding, or else to orientation of the folds in a fan shape. The resulting coating then exhibits a heterogeneous appearance, with matte zones and glossier zones, which distorts the appearance of the coating. Furthermore, these nonuniform coatings exhibit low soiling resistance, since the zones with fan-shaped folds retain dust and dirt.

US 2014/0371384 is a document relating to a method for mattifying a surface, comprising three irradiation steps for crosslinking a coating agent applied to a substrate.

US 2016/0145449 is a document describing a photocrosslinkable composition comprising a crosslinkable component, a filler, a UV stabilizer, a photoinitiator, and a component chosen from nonswellable fillers and swellable or soluble polymers.

US 2020/0024439 is a document relating to a crosslinked product manufactured by subjecting an acrylic composition to three irradiation steps.

There is a genuine need to provide a method which allows a matte coating to be obtained that is uniform, features improved soiling resistance, and can be used with a wide variety of crosslinkable components.

### SUMMARY OF THE INVENTION

The invention relates firstly to a method for coating a surface, comprising the following steps:
applying a layer of a curable composition to said surface;
irradiating the curable composition with a first radiation having a wavelength of 100 to 280 nm, so as to give a partially cured composition; and
irradiating the partially cured composition with a second radiation comprising at least one wavelength higher than the wavelength of the first radiation, and/or an electron beam, so as to give a cured composition;
wherein the curable composition comprises at least one compound curable by actinic radiation, and particles of at least one polyamide.

In some embodiments, the curable composition comprises from 0.01% to 2% by weight of particles of at least one polyamide, preferably from 0.01% to 1.5% by weight, relative to the total weight of the composition.

In some embodiments, the particles of the at least one polyamide have a volume-median diameter Dv50 of less than or equal to 20 μm, preferably from 1 to 20 μm.

In some embodiments, the polyamide is chosen from the group consisting of polyamide 12, polyamide 11, polyamide 10, polyamide 6, polyamide 6.10, polyamide 6.12, polyamide 6.6, polyamide 10.10, polyamide 10.12 and combinations thereof.

In some embodiments, the at least one compound curable by actinic radiation is an ethylenically unsaturated compound, preferably a compound comprising at least one group chosen from acrylate, methacrylate, cyanoacrylate, acrylamide, methacrylamide, styrene, maleate, fumarate, itaconate, allyl, propenyl, vinyl, methylidene malonate and combinations thereof, more preferably a compound comprising at least one functional group chosen from acrylate, methacrylate and vinyl, more preferably still a compound comprising at least one functional group chosen from acrylate and methacrylate.

In some embodiments, the curable composition comprises at least one photoinitiator, preferably chosen from the group consisting of benzoins, benzoin ethers, acetophenones, benzil, benzil ketals, anthraquinones, phosphine oxides, α-hydroxyketones, phenylglyoxylates, α-aminoketones, benzophenones, thioxanthones, xanthones, acridine derivatives, phenazene derivatives, quinoxaline derivatives, triazine derivatives and combinations thereof.

In some embodiments, the first radiation has a wavelength of 150 to 250 nm, preferably from 150 to 200 nm, more preferably from 168 to 180 nm, more preferentially from 172 to 175 nm.

In some embodiments, irradiating the curable composition with the first radiation is carried out using an excimer lamp.

In some embodiments, the second radiation has a wavelength spectrum in the range from 100 to 900 nm, preferably from 180 to 500 nm.

In some embodiments, the second radiation comprises at least one wavelength in the range from 285 to 900 nm, preferably in the range from 300 to 500 nm.

In some embodiments, the second radiation is emitted by an undoped mercury vapor lamp, a doped mercury vapor lamp or an LED lamp, preferably with a wavelength in the range from 350 to 405 nm.

In some embodiments, the layer of curable composition applied to the surface has a thickness of less than or equal to 100 μm, preferably less than or equal to 50 μm, more preferably less than or equal to 20 μm.

The invention also relates to a coating layer obtained by a method as described above.

The invention also relates to an object comprising a surface covered with a coating layer as described above.

The invention also relates to a composition comprising at least one compound curable by actinic radiation and from 0.01% to 2% by weight of particles of at least one polyamide, preferably from 0.01% to 1.5% by weight, relative to the total weight of the composition.

The invention also relates to a coating layer based on the composition described above.

The invention also relates to the use of an excimer lamp for at least partially curing a curable composition comprising at least one compound curable by actinic radiation, and particles of at least one polyamide.

The present invention serves to meet the need expressed above. It provides more particularly a method for coating a surface that allows a coating to be formed that features regular and enhanced mattness, having an improved appearance and in particular a uniform appearance, and exhibiting increased soiling resistance, increased wear resistance and increased chemical resistance. Moreover, the method according to the invention allows these advantageous properties to be obtained for a wide variety of curable compounds.

This is accomplished through the incorporation of polyamide particles into the curable composition and through the use of a method for curing said composition that comprises a first irradiation step for partially curing the composition and then a second irradiation step for continuing the crosslinking of the composition. Without wishing to be tied to a theory, the inventors consider that the polyamide particles dispersed in the curable composition create start and stop points for the folds at the surface of the layer of curable composition, these points being created during the first irradiation step, thereby enabling more effective control over the folds and consequently a better homogeneity of the folds at the surface and hence of the gloss of the coating.

Furthermore, the advantages above can be attained even with very small amounts of polyamide particles. Accordingly, in advantageous embodiments, the polyamide particles may be used in the curable composition in very small amounts, more particularly at less than the amounts conventionally employed for matting agents.

### BRIEF DESCRIPTION OF THE FIGURES

FIG. 1 represents a micrograph obtained by scanning electron microscopy (SEM) of the coating obtained from the curable composition A as described in the examples below.

FIG. 2 represents a micrograph obtained by scanning electron microscopy of the coating obtained from the curable composition 3 as described in the examples below.

### DETAILED DESCRIPTION

The invention is now described in greater detail and in a nonlimiting manner in the description that follows.

Unless otherwise indicated, all the percentages concerning amounts are mass percentages.

In the present text, the amounts indicated for a given species may apply to that species according to all its definitions (as mentioned in the present text), including the more restricted definitions.

In the context of the present invention, the terms “curing” and “crosslinking” have the same signification.

### Curable Composition

The curable composition used in the invention is preferably liquid at 25° C. The curable composition may alternatively be in gel form at 25° C. but in liquid form at a higher temperature (for example, at 120° C.).

The curable composition used in the invention comprises at least one compound curable by actinic radiation, and particles of at least one polyamide. “Actinic radiation” refers, conventionally, to any electromagnetic and/or ionizing radiation which is capable of inducing chemical reaction in a substance exposed to this radiation, and more particularly refers to radiation including ultraviolet (UV) radiation, visible light and electron beams.

The curable composition is advantageously a homogeneous dispersion. “Homogeneous dispersion” refers to a dispersion of polyamide particles in a liquid matrix comprising the curable compound. The homogeneity of the dispersion is thus a macroscopic homogeneity (which means that when observed with the naked eye, the dispersion is homogeneous in appearance), characterized in that the dispersion does not have a granular or phase-separated appearance.

The curable composition may have a viscosity at 25° C. of less than or equal to 100 000 mPa·s, preferably less than or equal to 50 000 mPa·s, more preferably less than or equal to 25 000 mPa·s, more preferably less than or equal to 10 000 mPa·s, more preferably less than or equal to 5000 mPa·s, as measured using a Brookfield DV-II viscometer employing a 27 spindle (the spindle speed varying typically between 20 and 200 rpm, depending on the viscosity).

### Compounds Curable by Actinic Radiation

The curable composition according to the invention comprises one or more compounds curable by actinic radiation. The compounds curable by actinic radiation that are introduced into the curable composition according to the invention are referred to collectively as the component curable by actinic radiation.

A compound curable by actinic radiation is intended in particular to be polymerized, in particular by radical polymerization reaction.

A compound curable by actinic radiation may in particular be an ethylenically unsaturated compound. In the sense of the invention, an “ethylenically unsaturated compound” means a compound which comprises a polymerizable carbon-carbon double bond. A polymerizable carbon-carbon double bond is a carbon-carbon double bond that can react with another carbon-carbon double bond in a polymerization reaction. Carbon-carbon double bonds in a phenyl ring are not considered as polymerizable carbon-carbon double bonds.

An ethylenically unsaturated compound may in particular be a compound comprising at least one group chosen from acrylate, methacrylate, cyanoacrylate, acrylamide, methacrylamide, styrene, maleate, fumarate, itaconate, allyl, propenyl, vinyl, methylidene malonate and corresponding combinations, more preferably a compound comprising at least one functional group chosen from acrylate, methacrylate, vinyl and combinations thereof, more preferably still a compound comprising at least one functional group chosen from acrylate, methacrylate and a combination thereof.

The component curable by actinic radiation may in particular comprise, or be, a (meth)acrylate-functionalized compound. The component curable by actinic radiation may comprise (or be) a mixture of (meth)acrylate-functionalized compounds.

As used here, the term “(meth)acrylate-functionalized compound” means a compound comprising at least one (meth)acryloyloxy group, more particularly an acryloyloxy group. The term “(meth)acryloyloxy group” encompasses acryloyloxy groups (—O—CO—CH═CH₂) and methacryloyloxy groups (—O—CO—C(CH₃)═CH₂).

The total amount of (meth)acrylate-functionalized compound in the component curable by actinic radiation may be from 20% to 100%, in particular from 30% to 100%, preferably from 40% to 100%, preferably from 50% to 100%, preferably from 60% to 100%, preferably from 70% to 100%, preferably from 80% to 100%, more preferably from 90% to 100%, by weight on the basis of the total weight of the component curable by actinic radiation. According to some embodiments, the component curable by actinic radiation does not comprise polymerizable compounds other than (meth)acrylate-functionalized compounds.

The component curable by actinic radiation may in particular comprise, or be, a (meth)acrylate-functionalized compound chosen from a (meth)acrylate-functionalized monomer, a (meth)acrylate-functionalized oligomer, and mixtures thereof. More particularly, the component curable by actinic radiation may comprise, or be, at least one (meth)acrylate-functionalized monomer and/or at least one (meth)acrylate-functionalized oligomer. With particular advantage, the component curable by actinic radiation comprises at least one (meth)acrylate-functionalized monomer and at least one (meth)acrylate-functionalized oligomer.

The component curable by actinic radiation may in particular comprise, or be, at least one (meth)acrylate-functionalized monomer. The component curable by actinic radiation may comprise (or be) a mixture of (meth)acrylate-functionalized monomers.

The (meth)acrylate-functionalized monomer may have a molecular weight of less than 600 g/mol, in particular from 70 to less than 550 g/mol, more particularly from 80 to 450 g/mol, more particularly from 90 to 350 g/mol.

The (meth)acrylate-functionalized monomer may contain 1 to 6 (meth)acryloyloxy groups, in particular 1 to 4 (meth)acryloyloxy groups.

The (meth)acrylate-functionalized monomer may comprise a mixture of (meth)acrylate-functionalized monomers having different functionalities. For example, the (meth)acrylate-functionalized monomer may comprise, or be, a mixture of a (or of at least one) (meth)acrylate-functionalized monomer containing a single acryloyloxy or methacryloyloxy group per molecule (referred to here as “mono(meth)acrylate-functionalized monomer”) and of a (or of at least one) (meth)acrylate-functionalized monomer containing 2 or more, preferably 2 to 6, acryloyloxy and/or methacryloyloxy groups per molecule (referred to here as “poly(meth)acrylate-functionalized monomer”).

The component curable by actinic radiation may in particular comprise, or be, at least one mono(meth)acrylate-functionalized monomer. The component curable by actinic radiation may in particular comprise, or be, a mixture of mono(meth)acrylate-functionalized monomers. A mono(meth)acrylate-functionalized monomer may advantageously function as a reactive diluent and reduce the viscosity of the curable composition according to the invention.

Examples of suitable mono(meth)acrylate-functionalized monomers include, but are not limited to, (meth)acrylic acid, mono(meth)acrylate esters of aliphatic alcohols (it being possible for the alcohol to be straight-chain or branched and to be a monoalcohol, a dialcohol or a polyalcohol, on condition that only one hydroxyl group is esterified by a (meth)acrylic acid); mono(meth)acrylate esters of cycloaliphatic or heterocyclic alcohols; mono(meth)acrylate esters of aromatic alcohols (such as phenols, including alkylated phenols); mono(meth)acrylate esters of alkylaryl alcohols (such as benzyl alcohol); mono(meth)acrylate esters of oligomeric and polymeric glycols (such as diethylene glycol, triethylene glycol, dipropylene glycol, tripropylene glycol, a polyethylene glycol, and a polypropylene glycol); mono(meth)acrylate esters of monoalkyl ethers of glycols and oligoglycols; caprolactone mono(meth)acrylates; and also the alkoxylated (e.g., ethoxylated and/or propoxylated) derivatives thereof; and the mixtures thereof.

The component curable by actinic radiation may in particular comprise a mono(meth)acrylate-functionalized monomer chosen from (meth)acrylic acid; methyl (meth)acrylate; ethyl (meth)acrylate; n-propyl (meth)acrylate; isopropyl (meth)acrylate; n-butyl (meth)acrylate; isobutyl (meth)acrylate; n-pentyl (meth)acrylate; n-hexyl (meth)acrylate; 2-ethylhexyl (meth)acrylate; n-octyl (meth)acrylate; isooctyl (meth)acrylate; n-decyl (meth)acrylate; isodecyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2-hydroxypropyl (meth)acrylate; 3-hydroxypropyl (meth)acrylate; 4-hydroxybutyl (meth)acrylate; 2-methoxyethyl (meth)acrylate; 2-ethoxyethyl (meth)acrylate; 2-ethoxypropyl (meth)acrylate; 3-ethoxypropyl (meth)acrylate; tetrahydrofurfuryl (meth)acrylate; 2-(2-ethoxyethoxy)ethyl (meth)acrylate; cyclohexyl (meth)acrylate; glycidyl (meth)acrylate; benzyl (meth)acrylate; 2-phenoxyethyl (meth)acrylate; phenol (meth)acrylate; nonylphenol (meth)acrylate; cyclic trimethylolpropane formal (meth)acrylate; isobornyl (meth)acrylate; tricyclodecane methanol (meth)acrylate; tert-butylcyclohexyl (meth)acrylate; trimethylcyclohexyl (meth)acrylate; diethylene glycol monomethyl ether (meth)acrylate; diethylene glycol monobutyl ether (meth)acrylate; triethylene glycol monoethyl ether (meth)acrylate; polyethylene glycol monomethyl ether (meth)acrylate; hydroxyl ethyl-butyl urethane (meth)acrylate; 3-(2-hydroxyalkyl) oxazolidinone (meth)acrylate; (2,2-dimethyl-1,3-dioxolan-4-yl) methyl (meth)acrylate; (2-ethyl-2-methyl-1,3-dioxolan-4-yl) methyl (meth)acrylate; 1,3-dioxan-5-yl (meth)acrylate; (1,3-dioxolan-4-yl) methyl (meth)acrylate; glycerol carbonate (meth)acrylate; and also the alkoxylated (for example, ethoxylated and/or propoxylated) derivatives thereof; and the mixtures thereof.

The component curable by actinic radiation preferably comprises, or is, a mono(meth)acrylate-functionalized monomer chosen from cyclohexyl acrylate, benzyl acrylate, 2-phenoxyethyl acrylate, nonylphenol acrylate, cyclic trimethylolpropane formal acrylate, isobornyl acrylate, tricyclodecanemethanol acrylate, tert-butylcyclohexyl acrylate, trimethylcyclohexyl acrylate, and mixtures thereof.

The component curable by actinic radiation may in particular comprise, or be, at least one poly(meth)acrylate-functionalized monomer.

Examples of poly(meth)acrylate-functionalized monomers include acrylate and methacrylate esters of polyols (organic compounds containing two or more hydroxyl groups per molecule; for example, 2 to 6 hydroxyl groups per molecule). Examples of suitable polyols are as follows: ethylene glycol, 1,2-or 1,3-propylene glycol, 1,2-, 1,3-or 1,4-butylene glycol, 1,5-pentanediol, 1,6-hexanediol, 1,8-octanediol, 1,9-nonanediol, 1,10-decanediol, 1,12-dodecanediol, 2-methyl-1,3-propanediol, 2,2-diethyl-1,3-propanediol, 3-methyl-1,5-pentanediol, 3,3-dimethyl-1,5-pentanediol, neopentyl glycol, 2,4-diethyl-1,5-pentanediol, cyclohexanediol, cyclohexane-1,4-dimethanol, norbornene dimethanol, norbornane dimethanol, tricyclodecanediol, tricyclodecane dimethanol, bisphenol A, B, F or S, hydrogenated bisphenol A, B, F or S, trimethylolmethane, trimethylolethane, trimethylolpropane, di(trimethylolpropane), triethylolpropane, pentaerythritol, di(pentaerythritol), glycerol, di-, tri- or tetraglycerol, polyglycerol, di-, tri- or tetraethylene glycol, di-, tri- or tetrapropylene glycol, di-, tri- or tetrabutylene glycol, one or more polyethylene glycols, one or more polypropylene glycols, one or more polytetramethylene glycols, one or more poly (ethylene glycol-co-propylene glycols), one or more alditols (more particularly, erythritol, threitol, arabitol, xylitol, ribitol, mannitol, sorbitol, galactitol, fucitol or iditol), one or more dianhydrohexitols (more particularly, isosorbide, isomannide or isoidide), tris (2-hydroxyethyl) isocyanurate, one or more polybutadiene polyols, and also the alkoxylated (for example, ethoxylated and/or propoxylated) derivatives thereof, the derivatives obtained by ring-opening polymerization of a lactone (for example, ¿-caprolactone) initiated with one of the abovementioned polyols, and mixtures thereof. Such polyols may be totally or partially esterified (with a (meth)acrylic acid, a (meth)acrylic anhydride, a (meth)acryloyl chloride or the like), with the proviso that they contain at least two (meth)acryloyloxy functional groups per molecule.

More particularly, the component curable by actinic radiation may especially comprise, or be, a poly(meth)acrylate-functionalized monomer chosen from bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-decanediol di(meth)acrylate; 1,12-dodecanediol di(meth)acrylate; 3-methyl-1,5-pentanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; glycerol di(meth)acrylate; glycerol tri(meth)acrylate; trimethylolethane tri(meth)acrylate; trimethylolethane di(meth)acrylate; trimethylolpropane tri(meth)acrylate; trimethylolpropane di(meth)acrylate; pentaerythritol di(meth)acrylate; pentaerythritol tri(meth)acrylate; pentaerythritol tetra(meth)acrylate; di(trimethylolpropane) di(meth)acrylate; di(trimethylolpropane) tri(meth)acrylate; di(trimethylolpropane) tetra (meth)acrylate; sorbitol penta (meth)acrylate; di(pentaerythritol) tetra (meth)acrylate; di(pentaerythritol) penta (meth)acrylate; di(pentaerythritol) hexa (meth)acrylate; tris (2-hydroxyethyl) isocyanurate tri(meth)acrylate; and also the alkoxylated (for example, ethoxylated and/or propoxylated) derivatives thereof; and the mixtures thereof.

The component curable by actinic radiation preferably comprises, or is, a poly(meth)acrylate-functionalized monomer chosen from 1,6-hexanediol diacrylate, 1,10-decanediol acrylate, 3-methyl-1,5-pentanediol diacrylate, neopentyl glycol diacrylate, tricyclodecanedimethanol diacrylate, trimethylolpropane triacrylate, di(trimethylolpropane) tetraacrylate, pentaerythritol tetraacrylate, di(pentaerythritol) pentaacrylate, and mixtures thereof.

The component curable by actinic radiation may comprise from 0% to 100%, in particular from 5% to 100%, more particularly from 10% to 100%, more particularly from 15% to 100%, more particularly from 20% to 95%, more particularly from 25% to 95%, more particularly from 30% to 95%, more particularly from 35% to 90%, more particularly from 40% to 90%, more particularly still from 50% to 90%, by weight of (meth)acrylate-functionalized monomer on the basis of the weight of the component curable by actinic radiation. Thus the component curable by actinic radiation may comprise from 0% to 60%, preferably from 5% to 60%, preferably from 10% to 60%, preferably from 15% to 60%, preferably from 20% to 60%, preferably from 25% to 60%, preferably from 30% to 60%, preferably from 35% to 60%, preferably from 40% to 60%, more preferably from 45% to 60% by weight of (meth)acrylate-functionalized monomer on the basis of the weight of the component curable by actinic radiation. As a variant, the component curable by actinic radiation may comprise from 60% to 100%, preferably from 65% to 100%, preferably from 70% to 100%, preferably from 75% to 100%, preferably from 80% to 100%, preferably from 85% to 100%, preferably from 90% to 100%, more preferably from 95% to 100%, by weight of (meth)acrylate-functionalized monomer on the basis of the weight of the component curable by actinic radiation.

The component curable by actinic radiation may in particular comprise, or be, at least one (meth)acrylate-functionalized oligomer. The component curable by actinic radiation may comprise, or be, a mixture of (meth)acrylate-functionalized oligomers.

The (meth)acrylate-functionalized oligomer may be chosen in order to enhance the flexibility, strength and/or modulus, among other attributes, of a product obtained by polymerizing the curable composition according to the present invention.

The (meth)acrylate-functionalized oligomer may have 1 to 18 (meth)acryloyloxy groups, in particular 2 to 6 (meth)acryloyloxy groups, more particularly 2 to 6 acryloyloxy groups.

The (meth)acrylate-functionalized oligomer may have a number-average molecular weight of greater than or equal to 600 g/mol, in particular from 800 to 15 000 g/mol, more particularly from 1000 to 5000 g/mol. The number-average molecular weight of the (meth)acrylate-functionalized oligomer may be measured by gel permeation chromatography (GPC).

In particular, the component curable by actinic radiation may comprise, or be, a (meth)acrylate-functionalized oligomer chosen from (meth)acrylate-functionalized urethane oligomers, (meth)acrylate-functionalized epoxy oligomers, (meth)acrylate-functionalized polyether oligomers, (meth)acrylate-functionalized polyester oligomers, (meth)acrylate-functionalized (meth)acrylic oligomers, (meth)acrylate-functionalized polydiene oligomers, (meth)acrylate-functionalized polycarbonate oligomers, (meth)acrylate-functionalized polyamide oligomers, and mixtures thereof.

(Meth)acrylate-functionalized urethane oligomers suitable for use in the curable compositions of the present invention include urethanes based on at least one polyol, on at least one polyisocyanate and on at least one hydroxyl-functionalized and (meth)acrylate-functionalized compound (also called hydroxyl-functionalized (meth)acrylate).

(Meth)acrylate-functionalized urethane oligomers may be prepared by reacting a polyisocyanate (for example, aliphatic, cycloaliphatic, heterocyclic or aromatic diisocyanate or triisocyanate) with a polyol (notably a polyester polyol, a polyether polyol, a polycarbonate polyol, a polycaprolactone polyol, a polyorganosiloxane polyol, a polydiene polyol such as a polybutadiene polyol, or corresponding combinations), to form isocyanate group-terminated oligomers which are then reacted with a hydroxyl-functionalized (meth)acrylate (such as hydroxyethyl (meth)acrylate) to provide terminal (meth)acrylate groups. For example, the (meth)acrylate-functionalized urethane oligomers may contain two, three, four or more (meth)acrylate functional groups per molecule. Other orders of addition may also be used to prepare the (meth)acrylate-functionalized urethane oligomer. For example, a hydroxyl-functionalized (meth)acrylate may be first reacted with a polyisocyanate to obtain an isocyanate-functionalized (meth)acrylate, which may then be reacted with a polyol. As a variant, all the components may be combined and reacted at the same time.

Examples of suitable (meth)acrylate-functionalized epoxy oligomers include the reaction products of (meth)acrylic acid (or a corresponding synthetic equivalent, such as acid chloride, alkyl ester or anhydride) with an epoxy resin comprising at least one epoxide group (in particular at least one group chosen from glycidyl ether, glycidyl ester and combinations thereof). The epoxy resin may, in particular, be chosen from bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy) cyclohexane-1,4-dioxane, bis(3,4-epoxycyclohexylmethyl) adipate, vinylcyclohexene oxide, 4-vinylepoxycyclohexane, bis(3,4-epoxy-6-methylcyclohexylmethyl) adipate, 3,4-epoxy-6-methylcyclohexyl-3′,4′-epoxy-6′-methylcyclohexanecarboxylate, methylenebis(3,4-epoxycyclohexane), dicyclopentadiene diepoxide, ethylene glycol bis(3,4-epoxycyclohexylmethyl) ether, ethylenebis(3,4-epoxycyclohexanecarboxylate), 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, polyglycidyl ethers of a polyether polyol obtained by the addition of one or more alkylene oxides to an aliphatic polyhydric alcohol, such as ethylene glycol, propylene glycol and glycerol, diglycidyl esters of long-chain aliphatic dibasic acids, monoglycidyl ethers of aliphatic higher alcohols, monoglycidyl ethers of phenol, cresol, butylphenol, or polyether alcohols obtained by the addition of alkylene oxide to these compounds, glycidyl esters of higher fatty acids, epoxidized soybean oil, epoxybutylstearic acid, epoxyoctylstearic acid, epoxidized linseed oil, an epoxidized polybutadiene, and the like.

Suitable (meth)acrylate-functionalized polyether oligomers include, but without being limited thereto, the reaction products of (meth)acrylic acid (or a corresponding synthetic equivalent, such as acid chloride, alkyl ester or anhydride) with at least one polyetherol which corresponds to a polyether polyol (such as a polyethylene glycol, a polypropylene glycol, a polytetramethylene glycol or a copolymer thereof). Suitable polyetherols may be linear or branched substances containing ether bonds and terminal hydroxyl groups. Polyetherols may be prepared by ring-opening polymerization of cyclic ethers such as tetrahydrofuran or alkylene oxides (for example ethylene oxide and/or propylene oxide) with a starting molecule. Suitable starting molecules include water, polyhydroxy-functionalized materials, polyester polyols and amines.

(Meth)acrylate-functionalized polyester oligomers given by way of example include the reaction products of (meth)acrylic acid (or a corresponding synthetic equivalent, such as acid chloride, alkyl ester or anhydride) with hydroxyl group-terminated polyester polyols. The reaction process can be performed so that all, or essentially all, the hydroxyl groups of the polyester polyol have been (meth)acrylated, particularly in cases where the polyester polyol is difunctional. Polyester polyols may be prepared by polycondensation reactions of polyhydroxy-functionalized components (in particular, diols) and poly (carboxylic acid)-functionalized compounds (in particular, dicarboxylic acids and anhydrides). The polyhydroxyl-functionalized components and poly (carboxylic acid)-functionalized components may each have linear, branched, cycloaliphatic or aromatic structures and may be used individually or as mixtures.

Suitable (meth)acrylate-functionalized (meth)acrylic oligomers (sometimes also known in the prior art as “acrylic oligomers”) comprise oligomers which may be described as substances having a (meth)acrylic backbone which is functionalized with one or more (meth)acrylate groups (which may be at an end of the oligomer or pendent to the (meth)acrylic backbone). The (meth)acrylic backbone may be a homopolymer, a random copolymer or a block copolymer composed of repeating units of (meth)acrylic-type monomers. The (meth)acrylic-type monomers may be any monomeric (meth)acrylates such as C1-C6 alkyl (meth)acrylates and/or functionalized (meth)acrylates such as (meth)acrylates bearing hydroxyl, carboxylic acid and/or epoxy groups. The (meth)acrylate-functionalized (meth)acrylic oligomers may be prepared by means of any procedure known in the prior art, such as oligomerization of monomers, at least some of which are functionalized with hydroxyl, carboxylic acid and/or epoxy groups (for example, hydroxyalkyl (meth)acrylates, a (meth)acrylic acid, a glycidyl (meth)acrylate) to obtain a functionalized oligomer intermediate, which is then reacted with one or more (meth)acrylate group-containing reactants to introduce the desired (meth)acrylate functional groups.

(Meth)acrylate-functionalized polydiene oligomers given by way of example include the reaction products of (meth)acrylic acid (or a corresponding synthetic equivalent, such as acid chloride, alkyl ester or anhydride) with hydroxyl group-terminated polydiene polyols, notably a hydroxyl group-terminated polybutadiene polyol.

(Meth)acrylate-functionalized polycarbonate oligomers given by way of example include the reaction products of (meth)acrylic acid (or a corresponding synthetic equivalent, such as acid chloride, alkyl ester or anhydride) with hydroxyl group-terminated polycarbonate polyols.

(Meth)acrylate-functionalized polyamide oligomers given by way of example include the reaction products of (meth)acrylic acid (or a corresponding synthetic equivalent, such as acid chloride, alkyl ester or anhydride) with hydroxyl group-terminated polyamide polyols.

The component curable by actinic radiation preferably comprises, or is, a (meth)acrylate-functionalized oligomer chosen from (meth)acrylate-functionalized urethane oligomers, (meth)acrylate-functionalized epoxy oligomers, (meth)acrylate-functionalized polyester oligomers and mixtures thereof. (Meth)acrylate-functionalized oligomers particularly preferred for the invention include the oligomers sold by Sartomer with the following commercial names: CN9200, CN9210, CN9276CN9301, CN963B80, CN964A85, CN965, CN981, CN991, CN996, CN998B80, CN104, CN203, CN2203EU, CN2295EU, CN2303EU, CN2505 and mixtures thereof.

The component curable by actinic radiation may comprise from 0% to 100%, in particular from 5% to 100%, more particularly from 10% to 100%, more particularly from 15% to 100%, more particularly from 20% to 95%, more particularly from 25% to 95%, more particularly from 30% to 95%, more particularly from 35% to 90%, more particularly from 40% to 90%, more particularly still from 50% to 90%, by weight of (meth)acrylate-functionalized oligomer on the basis of the weight of the component curable by actinic radiation. In particular, the component curable by actinic radiation may comprise from 0% to 60%, preferably from 5% to 60%, preferably from 10% to 60%, preferably from 15% to 60%, preferably from 20% to 60%, preferably from 25% to 60%, preferably from 30% to 60%, preferably from 35% to 60%, preferably from 40% to 60%, more preferably from 45% to 60% by weight of (meth)acrylate-functionalized oligomer on the basis of the weight of the component curable by actinic radiation. As a variant, the component curable by actinic radiation may comprise from 60% to 100%, preferably from 65% to 100%, preferably from 70% to 100%, preferably from 75% to 100%, preferably from 80% to 100%, preferably from 85% to 100%, preferably from 90% to 100%, more preferably from 95% to 100%, by weight of (meth)acrylate-functionalized oligomer on the basis of the weight of the component curable by actinic radiation.

The component curable by actinic radiation advantageously comprises:
from 10% to 90%, preferably from 20% to 80%, more preferably from 30% to 70%, more preferentially from 40% to 60%, by weight, of (meth)acrylate-functionalized monomer; and
from 10% to 90%, preferably from 20% to 80%, more preferably from 30% to 70%, more preferentially from 40% to 60%, by weight, of (meth)acrylate-functionalized oligomer;
   the % by weight being expressed relative to the weight of the component curable by actinic radiation.

The amount of component curable by actinic radiation in the curable composition is preferably from 50% to 99.99% by weight, more preferentially from 80% to 99.99% by weight, preferentially from 90% to 99.99% by weight, more preferentially still from 95% to 99.99% by weight.

### Polyamide Particles

The curable composition comprises particles of at least one polyamide. The polyamide particles are, in particular, a powder.

According to one embodiment, the particles consist of one or more polyamides.

The polyamide can be a homopolyamide and/or a copolyamide. It may consist solely of polyamide or may comprise one or more blocks of another type, for example chosen from polyether blocks, polyester blocks, polysiloxane blocks, such as polydimethylsiloxane (or PDMS) blocks, polyolefin blocks, polycarbonate blocks, and mixtures thereof.

The term “polyamide” is intended to mean a polymer comprising at least one product of polymerization of one or more monomers chosen from:
monomers of amino acid or aminocarboxylic acid type, and preferably α,ω-aminocarboxylic acids;
monomers of lactam type containing from 3 to 18 carbon atoms on the main ring and which may be substituted;
monomers of “diamine.diacid” type derived from the reaction between an aliphatic diamine containing from 2 to 36 carbon atoms, preferably from 4 to 18 carbon atoms, and a dicarboxylic acid containing from 4 to 36 carbon atoms, preferably from 4 to 18 carbon atoms; and
mixtures thereof, with monomers containing a different carbon number in the case of mixtures between a monomer of amino acid type and a monomer of lactam type.

In the present description, the term “monomer” should be taken to mean “repeat unit”. Indeed, a special case is where a repeating unit of the polyamide (PA) consists of the combination of a diacid with a diamine. It is considered that it is the combination of a diamine and a diacid, that is to say the diamine.diacid pair (in an equimolar amount), which corresponds to the monomer. This is explained by the fact that, individually, the diacid or the diamine is only a structural unit, which is not enough in itself alone to be polymerized.

When the polyamide is a homopolyamide, it comprises the product of polymerization of a single monomer as defined above. When the polyamide is a copolyamide, it comprises the product of polymerization of at least two different monomers as defined above. As examples of copolyamides formed from the various types of monomers described above, mention may be made of copolyamides resulting from the condensation of at least two α,ω-aminocarboxylic acids or of two lactams or of one lactam and one α,ω-aminocarboxylic acid. Mention may also be made of copolyamides resulting from the condensation of at least one α,ω-aminocarboxylic acid (or a lactam), at least one diamine and at least one dicarboxylic acid. Mention may also be made of copolyamides resulting from the condensation of an aliphatic diamine with an aliphatic dicarboxylic acid and at least one other monomer chosen from aliphatic diamines other than the preceding one and aliphatic diacids other than the preceding one.

Monomers of amino acid type:

As examples of α,ω-amino acids, mention may be made of those containing from 4 to 18 carbon atoms, such as aminocaproic acid, 7-aminoheptanoic acid, 11-aminoundecanoic acid, N-heptyl-11-aminoundecanoic acid and 12-aminododecanoic acid.

Monomers of lactam type:

As examples of lactams, mention may be made of those containing from 3 to 18 carbon atoms on the main ring and which may be substituted. Mention may be made, for example, of β,β-dimethylpropiolactam, α,α-dimethylpropiolactam, amylolactam, caprolactam, also known as lactam 6, capryllactam, also known as lactam 8, oenantholactam and lauryllactam, also known as lactam 12.

Monomers of “diamine.diacid” type:

Examples of dicarboxylic acid include acids having from 4 to 36 carbon atoms, preferably from 4 to 18 carbon atoms. Mention may be made, for example, of adipic acid, sebacic acid, azelaic acid, suberic acid, isophthalic acid, butanedioic acid, 1,4-cyclohexyldicarboxylic acid, terephthalic acid, the sodium or lithium salt of sulfoisophthalic acid, dimerized fatty acids (these dimerized fatty acids have a dimer content of at least 98% by weight and are preferably hydrogenated), dodecanedioic acid HOOC—(CH₂)₁₀—COOH and tetradecanedioic acid.

The term “fatty acid dimers” or “dimerized fatty acids” is more particularly understood to mean the product of the dimerization reaction of fatty acids (generally containing 18 carbon atoms, often a mixture of oleic and/or linoleic acid). It is preferably a mixture comprising from 0 to 15% by weight of C18 monoacids, from 60% to 99% by weight of C36 diacids, and from 0.2% to 35% by weight of triacids or polyacids of C54 or more.

Examples of diamines include aliphatic diamines having from 2 to 36 atoms, preferably from 4 to 18 atoms, more preferably from 6 to 12 carbon atoms, and which may be arylic and/or saturated cyclic. Examples that may be mentioned include hexamethylenediamine, piperazine (abbreviated as “Pip”), aminoethylenepiperazine, tetramethylenediamine, octamethylenediamine, 1,10-decamethylenediamine, dodecamethylenediamine, 1,5-diaminohexane, 2,2,4-trimethyl-1,6-diaminohexane, diamine polyols, isophoronediamine (IPD), methylpentamethylenediamine (MPMD), bis(aminocyclohexyl) methane (BACM), bis(3-methyl-4-aminocyclohexyl) methane (BMACM), meta-xylyenediamine and bis-p-aminocyclohexylmethane.

“Diamine.diacids” include more particularly those resulting from the condensation of 1,6-hexamethylenediamine with a dicarboxylic acid having from 6 to 36 carbon atoms, especially the following monomers: 6.6, 6.10, 6.11, 6.12, 6.14 and 6.18, and those resulting from the condensation of 1,10-decamethylenediamine with a diacid having from 6 to 36 carbon atoms, especially the following monomers: 10.10, 10.12, 10.14 and 10.18. In the numeral notation X.Y, X represents the number of carbon atoms derived from the diamine residues and Y represents the number of carbon atoms derived from the diacid residues, as is conventional.

The polyamide preferably comprises at least one of the following monomers: 4.6, 4.T, 5.6, 5.9, 5.10, 5.12, 5.13, 5.14, 5.16, 5.18, 5.36, 6, 6.6, 6.9, 6.10, 6.12, 6.13, 6.14, 6.16, 6.18, 6.36, 6.T, 9, 10.6, 10.9, 10.10, 10.12, 10.13, 10.14, 10.16, 10.18, 10.36, 10.T, 11, 12, 12.6, 12.9, 12.10, 12.12, 12.13, 12.14, 12.16, 12.18, 12.36, 12.T, and mixtures thereof.

Advantageously, the polyamide used in the invention is a polyamide (or comprises polyamide blocks) PA 6, PA 10, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, PA 6.6/6, PA 6.6/6.10/11/12, PA 10.10/11, PA 10.10/12, PA 10.10/14, PA 10.12/11, PA 10.12/12, PA 10.12/14, or mixtures or copolymers thereof. In the PA X notation, X represents the number of carbon atoms derived from amino acid residues or from lactam residues. The notations PA X/Y, PA X/Y/Z, etc. relate to copolyamides in which X, Y, Z, etc. represent homopolyamide units as described above.

Preferably, the polyamide according to the invention is chosen from PA 11, PA 12, PA 6, PA 6.X1, PA 10, PA 10.X2, PA 10.X3/Y1 or combinations thereof. Preferably, from the list above, X1 is chosen from 10, 12, 14 or 18. Preferably, from the list above, X2 is chosen from 10, 12 or 14. Preferably, from the list above, X3 is chosen from 10 or 12. Preferably, from the list above, Y1 is chosen from 11, 12 or 14.

Advantageously, the polyamide of the powder is one (or more) homopolyamide(s).

More preferably, the polyamide is chosen from the group consisting of polyamide 12, polyamide 11, polyamide 10, polyamide 6, polyamide 6.10, polyamide 6.12, polyamide 6.6, polyamide 10.10, polyamide 10.12 and combinations thereof. With particular preference, the polyamide is polyamide 12.

The polyamide may alternatively be a copolyamide. These include copolymers of caprolactam and of lauryllactam (PA 6/12), copolymers of caprolactam, of adipic acid and of hexamethylenediamine (PA 6/6.6), copolymers of caprolactam, of lauryllactam, of adipic acid and of hexamethylenediamine (PA 6/12/6.6), copolymers of caprolactam, of lauryllactam, of 11-aminoundecanoic acid, of azelaic acid and of hexamethylenediamine (PA 6/6.9/11/12), copolymers of caprolactam, of lauryllactam, of 11-aminoundecanoic acid, of adipic acid and of hexamethylenediamine (PA 6/6.6/11/12), copolymers of lauryllactam, of azelaic acid and of hexamethylenediamine (PA 6.9/12), copolymers of 11-aminoundecanoic acid, of terephthalic acid and of 1,10-decamethylenediamine (PA 11/10.T).

The polyamide according to the invention may be a mixture of polyamides, for example mixtures of aliphatic polyamides and of semiaromatic polyamides or mixtures of aliphatic polyamides and of cycloaliphatic polyamides. When the polyamide is a mixture of polyamides, the polyamide particles may consist of a mixture of particles of each polyamide, or each particle may comprise the mixture of polyamides.

Advantageously, the volume-median diameter Dv50 of the polyamide particles is less than or equal to 20 μm, preferably from 1 to 20 μm, more preferentially from 5 to 20 μm. More particularly, the volume-median diameter Dv50 of the polyamide particles may be from 1 to 5 μm, or from 5 to 10 μm, or from 10 to 15 μm, or from 15 to 20 μm. The Dv50 corresponds to the particle size at the 50th percentile (in volume) of the cumulative particle size distribution. It can be determined according to the standard ISO 9276-parts 1 to 6.

The polyamide powder according to the invention may be prepared by milling the polyamide in solid form—for example, in the form of pellets. The polyamide, and especially when it comprises a mixture of two or more polyamides, may preferably be melted and optionally mixed, for example in a compounder. It is subsequently milled after solidification. The milling may be accomplished by any means and may more particularly be selected from the group consisting of hammer milling, knife milling, disk milling, air-jet milling and cryogenic milling. The powder preparation process may also comprise a step of selecting the powder particles having the desired particle size.

The curable composition preferably comprises the polyamide particles in an amount of 0.01% to 2% by weight, more preferably from 0.01% to 1.5% by weight, more preferentially from 0.05% to 1.5% by weight, more preferentially still from 0.1% to 1.5% by weight, relative to the total weight of the composition. In particular, the polyamide particles may be present in an amount lower than the amounts in which matting agents are generally used to obtain a mattifying effect. In some embodiments, the curable composition may comprise from 0.01% to 0.05% by weight, or from 0.05% to 0.1% by weight, or from 0.1% to 0.2% by weight, or from 0.2% to 0.3% by weight, or from 0.3% to 0.5% by weight, or from 0.5% to 0.8% by weight, or from 0.8% to 1% by weight, or from 1% to 1.2% by weight, or from 1.2% to 1.5% by weight, or from 1.5% to 1.7% by weight, or from 1.7% to 2% by weight, of polyamide particles, relative to the total weight of the composition.

### Photoinitiators

The curable composition according to the invention may comprise at least one photoinitiator. The composition, and more particularly the compound or compounds curable by actinic radiation, are in that case preferably curable by radiative energy (visible light and/or ultraviolet light). A photoinitiator may be considered to be any type of substance which, when exposed to radiation (for example, actinic radiation), forms species which initiate the reaction and the curing of organic polymerization substances present in the curable composition. Photoinitiators suitable for the invention include free-radical photoinitiators, cationic photoinitiators and combinations thereof.

Polymerization initiators operating via a free-radical pathway are substances which form free radicals when they are irradiated. The use of free-radical photoinitiators is preferred. Nonlimitative examples of free-radical photoinitiators suitable for use in the curable compositions of the present invention comprise benzoins, benzoin ethers, acetophenones, benzil, benzil ketals, anthraquinones, phosphine oxides, α-hydroxyketones, phenylglyoxylates, α-aminoketones, benzophenones, thioxanthones, xanthones, acridine derivatives, phenazene derivatives, quinoxaline derivatives, triazine derivatives and mixtures thereof.

When a photoinitiator is present in the curable composition, it is present preferably in an amount of up to 15% by weight, based on the total weight of the curable composition, more particularly from 0.05% to 15% by weight. For example, the curable composition may advantageously comprise from 0.1% to 10% by weight of photoinitiator, based on the total weight of the curable composition. In some embodiments, the curable composition comprises from 0.05% to 0.5% by weight, or from 0.5% to 5% by weight, or from 5% to 10% by weight, or from 10% to 15% by weight of photoinitiator, relative to the total weight of the composition.

### Non-Reactive Solvent

The curable composition is preferably free of, or essentially free of, non-reactive solvent. As used here, the term “non-reactive solvent” denotes a solvent which is not curable by actinic radiation, in contrast to the compound or compounds curable by actinic radiation that are present in the composition. However, the non-reactive solvent may possibly react with one or more components of the composition via other mechanisms.

For example, the curable composition may comprise less than 5% by weight, less than 2% by weight, less than 1% by weight, less than 0.5% by weight, less than 0.1% by weight or even 0% by weight of non-reactive solvent, based on the total weight of the composition.

In some embodiments, the curable composition may include a certain amount of one or more non-reactive solvents. For example, a non-reactive solvent may be used to help solubilize one or more components of the composition and/or to reduce the viscosity of the composition. The type of non-reactive solvent that may be used is not limited, provided that it does not interfere with the capacity of the composition to be cured by exposure to actinic radiation. Suitable non-reactive solvents comprise, for example, ketones (e.g., acetone), esters, ethers, alcohols (including halogenated alcohols, such as fluoroalcohols, aromatic hydrocarbons, and the like) and combinations thereof. The composition curable by actinic radiation may include at least 0.5% by weight, or at least 1% by weight, or at least 2% by weight, or at least 5% by weight of one or more non-reactive solvents, based on the total weight of the composition. Alternatively, or additionally, the curable composition may comprise up to 90% by weight, or up to 80% by weight, or up to 70% by weight, or up to 60% by weight, or up to 50% by weight, or up to 40% by weight, or up to 30% by weight, or up to 25% by weight, or up to 20% by weight of one or more non-reactive solvents, based on the total weight of the composition. For example, the curable composition may comprise from 1% to 50% or from 1% to 25% by weight of non-reactive solvent.

The non-reactive solvent may be a volatile non-reactive solvent or a non-volatile non-reactive solvent. As used here, the term “volatile solvent” denotes a solvent having a boiling point at atmospheric pressure of less than or equal to 100° C. and the term “non-volatile solvent” denotes a solvent having a boiling point at atmospheric pressure of greater than 100° C. Combinations of volatile and non-volatile solvents may also be employed.

In the context of the present invention, it is also possible to use one or more non-reactive solvents when formulating the composition, in particular to help solubilize certain components, and then, after the components of the composition (including the one or more non-reactive solvents) have been combined, to carry out removal of at least a portion of the non-reactive solvent (up to the entirety of the non-reactive solvent) so as to provide the final curable composition, for use thereof in the method according to the invention. For example, the components of the composition may be combined and subsequently subjected to mixing and/or heating to give a product or a homogeneous solution, at least a portion of the non-reactive solvent being subsequently removed by appropriate means such as distillation or stripping under vacuum.

### Other Additives

The curable composition according to the invention may comprise one or more other additives. Such additives may, for example, be chosen from the group consisting of chain transfer agents, light-blocking agents (photoblockers), wetting agents (surface tension modifiers), matting agents, colorants, dyes, pigments, adhesion promoters, fillers, rheological agents/modifiers, flow control or leveling agents, thixotropic agents, plasticizers, light absorbers, light stabilizers, dispersants, antioxidants, antistats, lubricants, opacifiers, antifoams, polymerization inhibitors, and combinations thereof. Generally speaking, the curable composition may comprise any additive employed conventionally in the field of coatings.

The curable composition preferably comprises 2% by weight or less, more preferably 1% by weight or less, more preferably 0.5% by weight or less, more preferably 0.2% by weight or less, of matting agents, and more preferentially is devoid of matting agents. In the sense of the present invention, a “matting agent” is any particle, more particularly a polymeric or inorganic particle, that is used to create roughness at the surface of the coating, such as, for example, particles of silica, quartz, inorganic oxide, carbonate, nitride, polyorganosiloxane, elastomer or silsesquioxane or urea-methanal condensates, but excluding particles of polyamides described above (which therefore, in the context of the present invention, are not among the “matting agents”).

The curable compositions of the present invention may comprise one or more light-blocking agents (also called absorbers). The one or more light-blocking agents may be any known substances, including, for example, non-reactive pigments and non-reactive dyes. The light-blocking agent may be an agent which blocks visible light or an agent which blocks UV light, for example. Examples of suitable light-blocking agents comprise titanium dioxide, carbon black and organic ultraviolet-light absorbers such as hydroxybenzophenones, hydroxyphenylbenzotriazoles, oxalanilides, benzophenones, thioxanthones, hydroxyphenyltriazines, Sudan I, bromothymol blue, 2,2′-(2,5-thiophenediyl) bis(5-tert-butylbenzoxazole) (sold in particular under the trade name Benetex® OB Plus) and benzotriazole-type ultraviolet-light absorbers. The curable composition may contain a light-blocking agent in an amount of from 0.001% to 10% by weight, based on the weight of the curable composition.

### Preparation of the Curable Composition

The curable composition of the present invention may be prepared by any suitable method. For example, the various components may be combined and mixed, in one or more steps. The components may optionally be heated, preferably after having been combined and/or stirred, especially to give a homogeneous composition. Other homogenization methods may also be employed. Moreover, one or more non-reactive solvents may be used, as is described above. In some embodiments, the polyamide particles are added, preferably slowly, to the other components of the composition at a temperature of 20° C. to 90° C. while mixing.

### Coating Method

The curable composition as described above is used to form a coating on a surface.

The coating method according to the invention comprises applying the curable composition as a layer to a surface.

The surface may be any type of surface. The surface may for example be the surface of a high-surface-energy substrate, such as a metal substrate, or a low-surface-energy substrate, such as a plastic substrate. The substrate bearing the surface may comprise or consist of one or more metals, paper, cardboard, glass, one or more thermoplastic polymers such as polyolefins, polycarbonates, acrylonitrile-butadiene-styrene (ABS) polymers and mixtures thereof, a composite material, wood, leather or combinations thereof.

The curable composition may be applied to said surface in any known conventional way. More particularly, the composition may for example be applied by spraying, by knife coating, by roll coating, by an applicator bar, by flow coating, by drum coating, by dipping, or combinations thereof. Application may be carried out at room temperature (that is, from 15 to 30° C.) or at a higher temperature, especially at a temperature of 30 to 60° C. In particular, if the curable composition is not liquid or is too viscous at room temperature, it may be heated prior to its application to a temperature which enables it to liquefy or to reduce in viscosity, so as to facilitate its application. More particularly, the composition may for example be heated to about 50° C. for spraying applications which require the composition to have a very low viscosity.

The layer advantageously has a thickness of less than or equal to 100 μm (for example, from 1 to 100 μm), preferably less than or equal to 50 μm (for example, from 1 to 50 μm), more preferably less than or equal to 20 μm (for example, from 1 to 20 μm, preferably from 3 to 20 μm, more preferably from 10 to 20 μm). In particular, the layer of curable composition may have a thickness of 1 to 3 μm, or of 3 to 5 μm, or of 5 to 10 μm, or of 10 to 15 μm, or of 15 to 20 μm, or of 20 to 25 μm, or of 25 to 30 μm, or of 30 to 40 μm, or of 40 to 50 μm, or of 50 to 60 μm, or of 60 to 70 μm, or of 70 to 80 μm, or of 80 to 90 μm, or of 90 to 100 μm.

The layer of curable composition is subjected to a step of irradiation with a first radiation. This first radiation is preferably a monochromatic or quasi-monochromatic radiation. This first radiation is very advantageously a UV radiation and may be a VUV (“vacuum ultraviolet”) radiation. This first radiation is preferably applied by means of a UV lamp, and more preferably an excimer lamp. Excimer lamps (or lasers) are gas discharge lamps which emit monochromatic or quasi-monochromatic radiation. They generally have a synthetic quartz lamp body filled with xenon (for example, for emission at 172 nm) or with krypton with a chlorine donor (for example, for emission at 222 nm).

Irradiation is carried out preferably under an inert gas, more preferably under dinitrogen and/or carbon dioxide, more preferentially under dinitrogen. The residual oxygen content is preferably less than or equal to 1000 ppm, more preferably less than or equal to 500 ppm.

More preferably, the first radiation has a wavelength of 100 to 280 nm, preferably from 150 to 250 nm, more preferably from 150 to 200 nm, more preferably from 168 to 180 nm, more preferentially from 172 to 175 nm, more preferentially still of 172 nm. For example, the first radiation may have a wavelength of 100 to 125 nm, or of 125 to 150 nm, or of 150 to 175 nm, or of 175 to 200 nm, or of 200 to 225 nm, or of 225 to 250 nm, or of 250 to 280 nm.

The abovementioned wavelengths enable superficial curing of the layer of composition, meaning curing over a low thickness beneath its surface (typically over a thickness of about 1 μm or less, in particular over a thickness of about 0.5 μm), by means of a free-radical and/or cationic polymerization, for example. The solely superficial curing of the layer brings about the formation of folds at the surface of the layer.

This produces a partially cured, and more particularly surface-cured, composition. A “partially cured composition” means generally that additional curing is possible (more particularly, curing of the deeper part of the layer of curable composition).

This composition is subjected to a step of irradiation with a second radiation. This second radiation may be UV radiation or visible light, and/or electron beam radiation.

According to a first variant, the second radiation is UV radiation or visible light. It may be polychromatic or monochromatic. The second radiation comprises at least one wavelength different from that or those of the first radiation, and more particularly comprises at least one wavelength higher than that or those of the first radiation. Very preferably, it has a wavelength spectrum in the range from 100 to 900 nm. With further preference, the second radiation has a wavelength spectrum in the range from 180 to 500 nm. Alternatively or additionally, the second radiation may comprise UVA and/or UVB and/or UVC radiation, or may be UVA and/or UVB and/or UVC radiation.

The second radiation preferably comprises at least one wavelength higher than 280 nm, preferably in the range from [higher than 280 nm] to 900 nm, more preferably in the range from 285 to 900 nm, more preferentially in the range from 300 to 500 nm (in these embodiments, the second radiation may also optionally comprise wavelengths outside the ranges stated above). In particular, the second radiation may comprise at least one wavelength of from [higher than 280 nm] to 300 nm, or from 300 to 320 nm, or from 320 to 350 nm, or from 350 to 380 nm, or from 380 to 400 nm, or from 400 to 420 nm, or from 420 to 450 nm, or from 450 to 480 nm, or from 480 to 500 nm, or from 500 to 550 nm, or from 550 to 600 nm, or from 600 to 700 nm, or from 700 to 800 nm, or from 800 to 900 nm.

This radiation may be applied by a mercury vapor lamp, more particularly a medium-pressure or high-pressure mercury vapor lamp, the mercury vapor being optionally doped with elements such as gallium and/or iron, or a metal halide lamp, an electroluminescent diode (or LED for “light emitting diode”) and more particularly an LED which emits UV light, or a pulsed laser lamp (also called flash lamp). The second radiation is preferably emitted by an undoped mercury vapor lamp, by a doped mercury vapor lamp or by an LED lamp, the latter preferably having a wavelength of 350 nm to 405 nm.

The radiation dose applied during irradiation is advantageously from 80 to 4000 mJ/cm², preferably from 80 to 2000 mJ/cm², more preferably from 80 to 600 mJ/cm², for example from 80 to 300 mJ/cm², or from 300 to 600 mJ/cm², or from 600 to 1000 mJ/cm², or from 1000 to 2000 mJ/cm², or from 2000 to 3000 mJ/cm², or from 3000 to 4000 mJ/cm².

According to a second variant, the second radiation is an electron beam. The electron beam preferably has an energy of from 70 to 300 keV, preferably from 150 to 300 keV, for example from 70 to 150 keV, or from 150 to 200 keV, or from 200 to 250 keV, or from 250 to 300 keV. The irradiation dose is advantageously from 10 to 100 kGy, preferably from 20 to 50 kGy, for example from 10 to 20 kGy, or from 20 to 30 kGy, or from 30 to 40 kGy, or from 40 to 50 kGy, or from 50 to 70 kGy, or from 70 to 100 kGy. Any suitable electron-beam emitter may be used, especially a scanner or curtain-type emitter.

The step of irradiation with the second radiation may optionally be carried out in the absence of oxygen, for example in an inert gas atmosphere, or in an oxygen-depleted atmosphere. In some embodiments, the irradiation may be performed by covering the composition with a radiation-transparent medium (for example, a plastic film). Especially when the second radiation is an electron beam, it is preferably applied under inert gas.

The irradiation, whether taking place according to the first variant and/or according to the second variant, allows the curing of the layer to continue, by means for example of a free-radical and/or cationic polymerization. In particular, it allows the curing of the portion of the layer situated beneath the portion cured during exposure to the first radiation. The layer, preferably, is cured over its entire thickness. A cured composition is then obtained. In the sense of the present invention, a “cured composition” means that the degree of crosslinking of the composition after the step of irradiation with the second radiation is greater than that of the partially cured composition.

The coating, once cured, preferably has a thickness of less than or equal to 100 μm (for example, from 1 to 100 μm), preferably of less than or equal to 50 μm (for example, from 1 to 50 μm), more preferably from 10 to 20 μm. In particular, the cured layer may have a thickness of 1 to 5 μm, or of 5 to 10 μm, or of 10 to 15 μm, or of 15 to 20 μm, or of 20 to 25 μm, or of 25 to 30 μm, or of 30 to 40 μm, or of 40 to 50 μm, or of 50 to 60 μm, or of 60 to 70 μm, or of 70 to 80 μm, or of 80 to 90 μm, or of 90 to 100 μm.

The method according to the invention may comprise one or more other steps of curing the composition, more particularly by irradiation with actinic radiation. These supplementary steps may take place at any point in time in the method, in particular before irradiation with the first radiation, between irradiation with the first radiation and irradiation with the second radiation, and/or after irradiation with the second radiation. The radiation used in each of these supplementary steps may independently be of any known type.

In particular, the method according to the invention may comprise an irradiation step (referred to in the present text as “pre-crosslinking step”) before irradiation with the first radiation, the pre-crosslinking step being performed more preferably using UV radiation, more particularly UVA radiation. The pre-crosslinking is performed advantageously using radiation with a wavelength of 200 to 420 nm, more preferably of 280 to 420 nm. In some embodiments, the wavelength of the pre-crosslinking radiation may be from 200 to 280 nm, or from 280 to 320 nm, or from 320 to 380 nm, or from 380 to 420 nm. The radiation dose applied is preferably from 25 to 120 mJ/cm², more preferably from 30 to 100 mJ/cm². This radiation may be emitted by any suitable source, in particular by an LED lamp, a low-pressure, medium-pressure or high-pressure mercury vapor lamp (optionally doped with other elements such as gallium or iron), a pulsed (or flash) lamp, or a halogen lamp.

The emission sources for the first and second radiation, and possibly other radiation (for example, the pre-crosslinking radiation), may independently be stationary or mobile. When a source is stationary, the object whose surface is covered with the composition to be irradiated is preferably moved so as to pass in front of said irradiation source, being transported for example by means of a device such as a conveyor belt. When a source is mobile, the object comprising the composition to be irradiated is preferably left immobile during the step of irradiation by means of said source.

The method described above may be repeated one or more times. Accordingly, another layer of curable composition may be applied to the layer of cured composition and then subjected to curing by irradiation with actinic radiation, more particularly according to a method as described above.

The coating advantageously has a specular gloss at 85° of less than or equal to 10 GU, preferably less than or equal to 8 GU. The specular gloss at 85° can be measured according to the standard ISO 2813:2014.

According to another aspect, the invention relates to a coating layer obtained, or obtainable, from a curable composition as described above, and more particularly obtained by, or obtainable by, a method as described above.

According to another aspect, the invention relates to an object comprising a surface covered with a coating layer obtained, or obtainable, from a curable composition as described above. The invention also relates to an object comprising a surface covered with a coating layer obtained by, or obtainable by, a method as described above.

The object may be, for example, a furnishing panel, a garment, especially made of artificial leather, or a floor.

According to another aspect, the invention relates to the use of an excimer lamp for at least partially curing (or crosslinking) a curable composition comprising at least one compound curable by actinic radiation and particles of at least one polyamide. The excimer lamp advantageously has a wavelength of 150 to 250 nm, preferably from 150 to 200 nm, more preferably from 168 to 180 nm, more preferentially from 172 to 175 nm. The curable composition is preferably in layer form. The description above in relation in particular to the curable composition, the polyamide, the layer of curable composition and the excimer lamp and use thereof may apply similarly to this aspect of the invention.

### EXAMPLES

The following examples illustrate the invention without limiting it.

### Preparation of the Curable Compositions

The following curable compositions were prepared, comprising the components in the amounts (indicated as a mass percentage) specified in the table below.

TABLE 1

| | A | | | |
|---|---|---|---|---|
| Composition no. | (comp.) | 1 | 2 | 3 |
| Acrylate-functionalized | 48.78% | 48.40% | 48.55% | 48.64% |
| epoxy oligomer (CN2003EU | | | | |
| from Sartomer) | | | | |
| 1,6-Hexanediol diacrylate | 48.78% | 48.40% | 48.55% | 48.64% |
| (SR238 from Sartomer) | | | | |
| Phosphine oxide | 0.50% | 0.40% | 0.46% | 0.51% |
| photoinitiator (Speedcure ® | | | | |
| TPO-L from Lambson) | | | | |
| Hydroxyacetophenone | 1.95% | 1.40% | 1.63% | 1.77% |
| photoinitiator (Speedcure ® | | | | |
| 84 from Lambson) | | | | |
| Polyamide 12 powder with | 0.00% | 1.40% | 0.82% | 0.44% |
| Dv50 of 10 μm (Orgasol ® | | | | |
| 2001 EXD Nat1 from | | | | |
| Arkema) | | | | |

Composition A is a comparative curable composition; compositions 1, 2 and 3 are curable compositions according to the invention.

The compositions were prepared in the following way:

Preparation of the pre-dispersion of polyamide 12 powder (=premix B)

5 g of the polyamide 12 powder were introduced with stirring at 1000 revolutions/minute by means of a disperser equipped with a turbine in a mixture of 47.5 g of acrylate-functionalized epoxy oligomer (CN2003EU from Sartomer) and 47.5 g of 1,6-hexanediol diacrylate (SR238 from Sartomer). The polyamide 12 powder was introduced in about a quarter of an hour in small portions, to allow the powder to disperse properly. When introduction was finished, the mixture was left with stirring for a further quarter of an hour. Preparing a premix of the PA 12 powder in the product CN2003EU enables effective dispersion of the polyamide 12 powder during the preparation of the end compositions.

Preparation of the compositions:

Composition A (comparative):

195.10 g of acrylate-functionalized epoxy oligomer (CN2003EU from Sartomer) were diluted with stirring using the same disperser in 195.10 g of 1,6-hexanediol diacrylate (SR238 from Sartomer). The following were subsequently introduced in this order, with stirring: 2.00 g of phosphine oxide photoinitiator (Speedcure® TPO-L from Lambson) and 7.80 g of hydroxyacetophenone photoinitiator (Speedcure® 84 from Lambson). The formulation was left with stirring for a further quarter of an hour.

### Composition 1:

35.10 g of acrylate-functionalized epoxy oligomer (CN2003EU from Sartomer) were diluted with stirring using the same disperser in 35.10 g of 1,6-hexanediol diacrylate (SR238 from Sartomer). The following were subsequently introduced in this order, with stirring: 28.10 g of premix β, then 0.40 g of phosphine oxide photoinitiator (Speedcure® TPO-L from Lambson) and 1.40 g of hydroxyacetophenone photoinitiator (Speedcure® 84 from Lambson). The formulation was left with stirring for a further quarter of an hour.

### Composition 2:

35.10 g of acrylate-functionalized epoxy oligomer (CN2003EU from Sartomer) were diluted with stirring using the same disperser in 35.10 g of 1,6-hexanediol diacrylate (SR238 from Sartomer). The following were subsequently introduced in this order, with stirring: 14.05 g of premix β, then 0.40 g of phosphine oxide photoinitiator (Speedcure® TPO-L from Lambson) and 1.40 g of hydroxyacetophenone photoinitiator (Speedcure® 84 from Lambson). The formulation was left with stirring for a further quarter of an hour.

### Composition 3:

35.10 g of acrylate-functionalized epoxy oligomer (CN2003EU from Sartomer) were diluted with stirring using the same disperser in 35.10 g of 1,6-hexanediol diacrylate (SR238 from Sartomer). The following were subsequently introduced in this order, with stirring: 7.025 g of premix β, then 0.40 g of phosphine oxide photoinitiator (Speedcure® TPO-L from Lambson) and 1.40 g of hydroxyacetophenone photoinitiator (Speedcure® 84 from Lambson). The formulation was left with stirring for a further quarter of an hour.

### Preparation of the Coatings

A coating with a thickness of 12 μm was formed on a film of polyethylene terephthalate (PET) from each of the curable compositions described above.

To accomplish this, the curable compositions were applied using a 12 μm applicator bar to a rigid support plate of PET. These compositions were subsequently crosslinked according to the following protocol: the films coated with a curable composition were arranged on a conveyor belt, allowing them to be passed successively under a UV LED lamp (to perform pre-crosslinking), an excimer lamp and lastly another UV lamp. The operating parameters are as follows:
Belt speed: 10 m/s.
Crosslinking with Xeradex® excimer lamp with a power of 5 W/cm and a wavelength of 172 nm, regulated at a power of 50%.
UV crosslinking with IST I-400-U-3-80 mercury vapor lamp with a maximum power of 200 W/cm, regulated at a power of 70% (corresponding to a dose of 750 mW/cm²) and emitting in the UVA, UVB and UVC.

Tests conducted:

The following tests were carried out on the coatings obtained as described above:
Coating appearance: the coating was observed by optical microscopy and scanning electron microscopy.
The number of defects was counted in an 8 cm×8 cm square on the image obtained by optical microscopy.
Specular gloss at 85°: measured using a glossmeter according to the standard ISO 2813:2014.
Buffing resistance: the buffing resistance is estimated as the increase in gloss as measured according to the standard ISO 2813:2014 after the coating has undergone rubbing with a standardized white woollen felt (150 back-and-forth strokes) according to the standard ISO 11640:2018 to which a weight of 3.5 kg is applied. The smaller the increase in gloss of the coating which has undergone rubbing, the better the buffing resistance.
Chemical resistance: the chemical resistance is estimated by means of a wad of cotton (1.5 cm×1.5 cm×0.5 cm) saturated with methyl ethyl ketone which is rubbed (back-and-forth strokes) on the surface of the coating under a weight of 1 kg. The back-and-forth strokes are performed and counted until the coating breaks up or detaches from the substrate. The higher the number of cycles before this occurs, the better the chemical resistance.
Soiling resistance: this property is determined by the change in color of the coating after it has been exposed to black iron oxide dust (ΔE). The initial color of the coatings is measured on an Insitec spectrophotometer from Malvern by means of their coordinates L*, a*, b* according to the standard ISO 18314. A 33% black iron oxide soiling solution in water is applied by means of a soft brush to the surface of the coating. The solution is left in contact with the coating for 3 hours at 23° C. and subsequently at 60° C. for 1 hour and lastly is left to dry at 23° C. for 20 hours. The excess soiling solution is removed by means of a soft brush and then the color of the coating is measured by means of its coordinates L*, a*, b* according to the standard ISO 18314 and compared with the color of the unsoiled coating. The difference in color is expressed by the ΔE* as calculated according to the formula ΔE*=\sqrt{(ΔL)²+(Δa)²+(Δb)²} in which ΔL, Δa and Δb respectively are the differences in the coordinates L*, a* and b* between the soiled coating and the unsoiled coating, according to the standard ISO 18314. The lower the ΔE*, the better the soiling resistance of the coating.

### Results

The results are indicated in the table below:

TABLE 2

| Composition no. | A | 1 | 2 | 3 |
|---|---|---|---|---|
| Appearance of the | Presence of | Homogeneous | Homogeneous | Homogeneous |
| coating | defects | | | |
| Number of defects | 50 | 3 | 1 | 3 |
| on the coating | | | | |
| Specular gloss at 85° | 8.2 | 5.8 | 6.1 | 7.4 |
| (GU) | | | | |
| Buffing resistance | 8.1 | 1.6 | 2.1 | 2.9 |
| (delta gloss (GU)) | | | | |
| Chemical resistance | 168 | 260 | 260 | 260 |
| (number of cycles) | | | | |
| Soiling resistance | 3.2 | 2.3 | 2.3 | 2.4 |
| (ΔE*) | | | | |

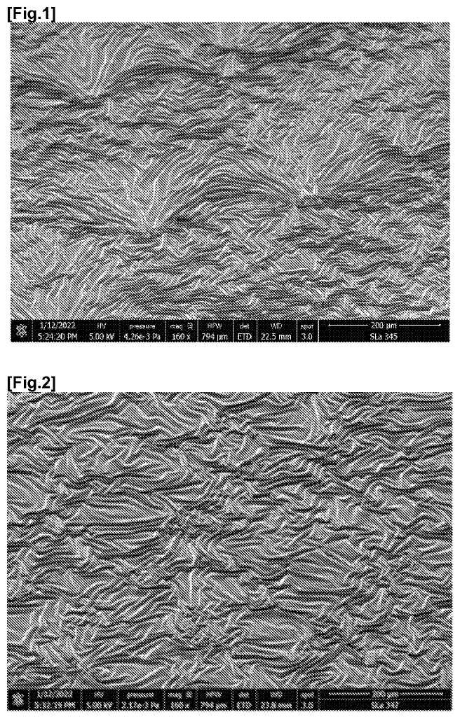

Micrographs obtained by scanning electron microscopy of the coating formed from composition A and of the coating formed from composition 3 are shown in FIG. 1 and FIG. 2 respectively.

It is found that the coatings obtained from curable compositions comprising polyamide particles have a homogeneous appearance, virtually without any defect present, whereas the coating obtained from composition A (devoid of polyamide particles) exhibits numerous defects, these being folds oriented in a fan shape.

Moreover, the coatings obtained from curable compositions according to the invention are more matte (i.e., have a lower gloss) and exhibit greater buffing resistance, greater chemical resistance and greater soiling resistance relative to the coating obtained from comparative composition A.

Two comparative examples (4 and 5) were prepared in the same way as composition 1 except that 1.4% of silica was added in the place of 1.4% of polyamide 12 powder.

TABLE 3

| | 4 | 5 |
|---|---|---|
| Composition | (comp.) | (comp.) |
| Acrylate-functionalized | 48.40% | 48.40% |
| epoxy oligomer (CN2003EU | | |
| from Sartomer) | | |
| 1,6-Hexanediol diacrylate | 48.40% | 48.40% |
| (SR238 from Sartomer) | | |
| Phosphine oxide | | |
| photoinitiator (Speedcure ® | 0.40% | 0.40% |
| TPO-L from Lambson) | | |
| Hydroxyacetophenone | 1.40% | 1.40% |
| photoinitiator (Speedcure ® | | |
| 84 from Lambson) | | |
| Silica powder | 1.40% Acematt ® | 1.40% Gasil ® |
| | TS100 | UV70C |

TABLE 4

| | | 4 | 5 |
|---|---|---|---|
| Composition | 1 | (comp.) | (comp.) |
| Appearance of the | Homogeneous | Presence of | Presence of |
| coating | | defects | defects |
| Number of defects | 3 | 20 | 30 |
| on the coating | | | |

It is found that the coatings obtained from compositions comprising silica particles exhibit numerous defects, these being folds oriented in a fan shape, and are therefore less resistant to soiling, owing to the presence of attachment points (defects).

1. A method for coating a surface, comprising the following steps:
applying a layer of a curable composition to said surface;
irradiating the curable composition with a first radiation having a wavelength of 100 to 280 nm, so as to give a partially cured composition; and
irradiating the partially cured composition with a second radiation comprising at least one wavelength higher than the wavelength of the first radiation, and/or an electron beam, so as to give a cured composition;
wherein the curable composition comprises at least one compound curable by actinic radiation, and particles of at least one polyamide.

2. The method as claimed in claim 1, wherein the curable composition comprises from 0.01% to 2% by weight of particles of at least one polyamide, relative to the total weight of the composition.

3. The method as claimed in claim 1, wherein the particles of the at least one polyamide have a volume-median diameter Dv50 of less than or equal to 20 μm.

4. The method as claimed in claim 1, wherein the polyamide is chosen from the group consisting of polyamide 12, polyamide 11, polyamide 10, polyamide 6, polyamide 6.10, polyamide 6.12, polyamide 6.6, polyamide 10.10, polyamide 10.12 and combinations thereof.

5. The method as claimed in claim 1, wherein the at least one compound curable by actinic radiation is an ethylenically unsaturated compound.

6. The method as claimed in claim 1, wherein the curable composition comprises at least one photoinitiator.

7. The method as claimed in claim 1, wherein the first radiation has a wavelength of 150 to 250 nm.

8. The method as claimed in claim 1, wherein irradiating the curable composition with the first radiation is carried out using an excimer lamp.

9. The method as claimed in claim 1, wherein the second radiation has a wavelength spectrum in the range from 100 to 900 nm.

10. The method as claimed in claim 1, wherein the second radiation comprises at least one wavelength in the range from 285 to 900 nm.

11. The process as claimed in claim 1, wherein the second radiation is emitted by an undoped mercury vapor lamp, a doped mercury vapor lamp or an LED lamp.

12. The method as claimed in claim 1, wherein the layer of curable composition applied to the surface has a thickness of less than or equal to 100 μm.

13. A coating layer obtained by a method as claimed in claim 1.

14. An object comprising a surface covered with a coating layer as claimed in claim 13.

15. A composition comprising at least one compound curable by actinic radiation and from 0.01% to 2% by weight of particles of at least one polyamide, relative to the total weight of the composition.

16. A coating layer based on the composition as claimed in claim 15.

17. A method comprising using an excimer lamp for at least partially curing a composition as claimed in claim 15.
